(19) United States
(12) Patent Application Publication
(10) Pub. No.: US 2016/0271579 A1
(43) Pub. Date: Sep. 22, 2016

(54) SPRAYING DEVICE FOR QUICKLY FORMING GAS HYDRATES

(71) Applicant: GUANGZHOU INSTITUTE OF ENERGY CONVERSION, CHINESE ACADEMY OF SCIENCES, Guangzhou City, Guangdong (CN)

(72) Inventors: Xiaosen LI, Guangzhou City (CN); Chungang XU, Guangzhou City (CN); Zhaoyang CHEN, Guangzhou City (CN); Gang LI, Guangzhou City (CN); Yu ZHANG, Guangzhou City (CN)

(73) Assignee: GUANGZHOU INSTITUTE OF ENERGY CONVERSION, CHINESE ACADEMY OF SCIENCES, Guangzhou City, Guangdong (CN)

(21) Appl. No.: 14/765,463

(22) PCT Filed: Oct. 22, 2014
(86) PCT No.: PCT/CN2014/089123

§ 371 Date: Aug. 3, 2015

(30) Foreign Application Priority Data
Dec. 10, 2013 (CN) 201310670233.8

(51) Int. Cl. B01J 19/26; B01D 53/30; B01F 15/00; B01F 3/04; B01F 15/06; B01D 53/00; B01J 4/00

(52) U.S. Cl. CPC B01J 19/26; B01D 53/002; B01D 53/30; B01J 4/002; B01F 3/04021; B01F 3/0446; B01F 15/06; B01F 15/00136; B01F 15/00253; B01J 2219/00058; B01J 2219/00065; B01J 2219/00069; B01F 2015/061

(57) ABSTRACT

A spraying device for quickly forming gas hydrates, includes a stable gas supply system, a saturated solution preparation system, a gas-liquid mixed sprayer, a temperature control system and a data collecting and processing system. Pressure atomization is achieved at a high atomization speed and the atomized fog drops are uniformly distributed within a scale range of 5-10 microns to form a gas-in-water contact mode, so as to effectively increase a gas-water contact superficial area and significantly shorten the induction time of forming the gas hydrates. The device achieves gas-liquid intensive mixing in a gas-liquid mixing cavity in a spray manner and consumes no energy, thereby reducing the total energy consumption of forming the gas hydrates and improving the energy consumption efficiency of forming the gas hydrates. The spraying device applies to thermodynamics and kinetics experiments of quick and continuous hydrate method gas separation and rapid formation of the gas hydrates.

### FIELD OF THE INVENTION

The present invention relates to a spraying device for quickly forming gas hydrates.

### BACKGROUND OF THE INVENTION

A gas hydrate (Gas Hydrate) is an ice-like crystal mixture formed by water molecules and small molecules of a guest gas and is generally formed under the conditions of low temperature and high pressure, the water molecules are connected by hydrogen bonds to form a series of polyhedral holes with different sizes and different structures, and guest molecules with different sizes enter these holes and stably exist under the action of the Van der Waals force. The phase equilibrium conditions of different guest molecules for forming the gas hydrate are different, therefore, under the same conditions, the hydrate has selectivity on different guest molecules, the guest molecules with milder phase equilibrium conditions can preferentially enter to form the gas hydrate, resulting in variation of gas components in a hydrate phase and a gaseous phase, the components of the gas hydrate are easier to enrich in the hydrate phase, and the components of the gas hydrate become thin in the gaseous phase, therefore, a gas can be separated from a mixed gas and extracted by means of a hydrate method. Compared with the traditional gas separation technology (for example, chemical absorption, physical adsorption, membrane separation or the like), the hydrate method gas separation technology has the advantages of lower energy consumption, better environmental friendliness and the like, thus the research on the hydrate method gas separation technology has become a hot spot worldwide, and the hydrate method gas separation process and application are the key points of converting the technology into industrial application.

At present, the research on the hydrate method gas separation process is restricted to a formation velocity of the gas hydrate and gas separation efficiency, and especially in a technological process, the formation velocity of the gas hydrate is a key factor restricting the hydrate method gas separation technology. Analyzed from two aspects of thermodynamics and kinetics of hydrate formation, one of the key factors influencing the formation of the gas hydrate is a gas-water contact area The larger the gas-water contact area is, the better the dissolution of the gas in an aqueous phase is, the fugacity of the gas in the aqueous phase is increased correspondingly, so as to further improve the driving force of forming the gas hydrate and provide conditions for quickly forming the gas hydrate. The manner of forming the gas hydrate usually includes a stirring method, a spray method, a bubbling method and the like, and the purpose of these methods is to promote intensive mixing of the gas and water and increase the gas-water contact area The stirring method includes mechanical stirring and electromagnetic stirring, the mechanical stirring is suitable for reactors with larger volumes, with the stirring speed being consistent, while the electromagnetic stirring is limited to magnetic force acting and is only suitable for miniature reactors, moreover, with the stirring speed being decreased with the formation of the hydrate and the increase of the system viscosity. However, the system is easier to seal under the magnetic stirring, which is particularly important in a high pressure environment. The spray method is to spray water into a reaction kettle filled with gas through a spray pipe to form a gas-in-water form in the space, so as to promote gas-water contact; on the contrary, the bubbling method is to fill the gas in the reaction kettle filled with water in the form of bubbles by means of a bubble generation dish to form the gas-in-water form, so as to promote gas-water contact. Compared with a static system, these methods are apparently helpful to promote the dissolution of the gas in water and increase the gas-water contact area, and can relatively shorten the induction time of forming the gas hydrate and improve the hydrate formation velocity, which has been verified in a lot of experimental studies. However, since the formation of the gas hydrate is a growth process of a micro crystal nucleus, the gas-water contact caused by the stirring method, the spray method, the scale of the bubbling method and the like is much larger than a microscopic nucleation scale, such that the gas-water contact area is not large enough, and the gas-water contact is insufficient to significantly improve the formation velocity of the gas hydrate to meet the requirements of technologized production.

### SUMMARY OF THE INVENTION

The present invention provides a spraying device for quickly forming gas hydrates, for overcoming the key problem restricting the rapid formation of gas hydrates, namely full gas-water contact, this device fully mixes a gas with water and atomizes the mixture into fog drops of 5-10 microns to significantly increase a gas-water contact area and improve the fugacity of the gas in an aqueous phase, so as to improve the driving force of forming the gas hydrates, shorten the induction time of forming the gas hydrates and improve the formation velocity of the gas hydrates.

The present invention is achieved by the following technical solutions:

a spraying device for quickly forming gas hydrates includes a stable gas supply system, a saturated solution preparation system, a gas-liquid mixed sprayer, a temperature control system and a data collecting and processing system, which are connected by pipelines or circuits; the stable gas supply system is composed of a test gas cylinder, a CO₂ gas cylinder, a pressure reducing valve and a booster pinup, and the stable gas supply system provides a gas for the saturated solution preparation system and the gas-liquid mixed sprayer; the saturated solution preparation system is composed of a solution tank and a booster pump, and the saturated solution preparation system provides a saturated solution for the gas-liquid mixed sprayer; the interior of the gas-liquid mixed sprayer includes a high speed fluid cavity, a gas-liquid mixing cavity communicated with the high speed fluid cavity and an atomizer arranged in the gas-liquid mixing cavity; the test gas cylinder is communicated with the gas-liquid mixing cavity of the gas-liquid mixed sprayer through the pressure reducing valve and a gas flowmeter; two gas pipelines are arranged at the top end of the CO₂ gas cylinder, one gas pipeline is communicated with the bottom of the solution tank through the booster pump, and the other gas pipeline is communicated with the top of the solution tank; the solution tank is communicated with the high speed fluid cavity of the gas-liquid mixed sprayer through the booster pump; the temperature control system includes a temperature control refrigerating system and a constant temperature chamber arranged at the peripheries of the solution tank and the gas-liquid mixed sprayer, and the temperature control system controls the temperature change of the solution tank and the gas-liquid mixed sprayer; the data collecting and processing system includes a liquid flowmeter, the gas flowmeter a data collector and a computer processing system, and the data collecting and processing system is used for controlling, collecting, storing and analyzing the temperature, pressure, gas flow and liquid flow data of the stable gas supply system, the saturated solution preparation system, the gas-liquid mixed sprayer and the temperature control system.

The interior of the gas-liquid mixed sprayer is hollow, and trapezoidal projections are symmetrically arranged on the inner wall to divide the interior of the gas-liquid mixed sprayer into the high speed fluid cavity and the gas-liquid mixing cavity, which are intercommunicated; a gas flow inlet is formed in the convex end close to the high speed fluid cavity in the gas-liquid mixing cavity, and the gas-liquid mixed sprayer further includes a spray head arranged at the outer end of the atomizer and distributors uniformly distributed on the spray head.

The atomizer is fixedly connected with the wall of the gas-liquid mixed sprayer through a threaded connector and a gasket.

The spray head is annular and detachable, and the spray head is preferably connected with the atomizer through internal threads.

The inside diameter of the distributor is 0.04-1.0 mm.

The present invention further protects an application of the spraying device for quickly forming gas hydrates, and the spraying device for quickly forming gas hydrates is applied to thermodynamics and kinetics experiments of quick and continuous hydrate method gas separation and rapid formation of the gas hydrates.

The present invention has the following beneficial effects:

(1) the upper limit of the working pressure of the device is up to 8 MPa, thus high pressure gas-liquid mixing can be performed:

(2) the device achieves pressure atomization, the atomization speed is fast, the atomized fog drops are uniformly distributed within a scale range of 5-10 microns, the fog, drops are enclosed in a gas environment in the device to form a gas-in-water contact mode, thereby effectively increasing the gas-water contact superficial area and significantly shortening the induction time of forming the gas hydrates under proper temperature and pressure conditions, and the gas hydrates can be formed instantly, so that the device can be widely applied to the thermodynamics and kinetics experiments of quick and continuous hydrate method gas separation and rapid formation of the gas hydrates.

(3) the device achieves intensive gas-liquid mixing in the gas-liquid mixing cavity in a spray manner and consumes no energy, thereby effectively reducing the total energy consumption of forming the gas hydrates and improving the energy consumption efficiency of forming the gas hydrates;

(4) the device is convenient to use, the annular spray head is detachable and replaceable, the internal thread connection manner is adopted to not only change the ring radius according to process demand, but also clean the spray head at any time to prevent, the blockage of the spray head.

### BRIEF DESCRIPTION OF THE DRAWINGS

FIG. 1 is a schematic diagram of a spraying device in the present invention;

FIG. 2 is a cross-section view of a gas-liquid mixed sprayer in the present invention;

FIG. 3 is a schematic diagram of a distributor of an annular spray head;

in which: 1. test gas cylinder; 3. booster pump; 4. CO₂ gas cylinder; 2, 5, 6, 10, 12, 14, 17, 19, 20, 21, 24: valve; 7. constant temperature chamber; 8. solution tank; 9. deionized water; 11. booster pump; 13. liquid flowmeter; 15. gas-liquid mixed sprayer; 16; temperature control refrigerating system; 18. pressure reducing valve; 22. gas flowmeter; 23. data collector; 25, computer processing system; 26. high speed fluid cavity; 27. gas-liquid mixing cavity; 28. threaded connector; 29. spray head; 30. distributor; 31. gas flow inlet; 32. atomizer; 33. gasket.

### DETAILED DESCRIPTION OF THE EMBODIMENTS

The following description is further illustration of the present invention, rather than limitation to the present invention.

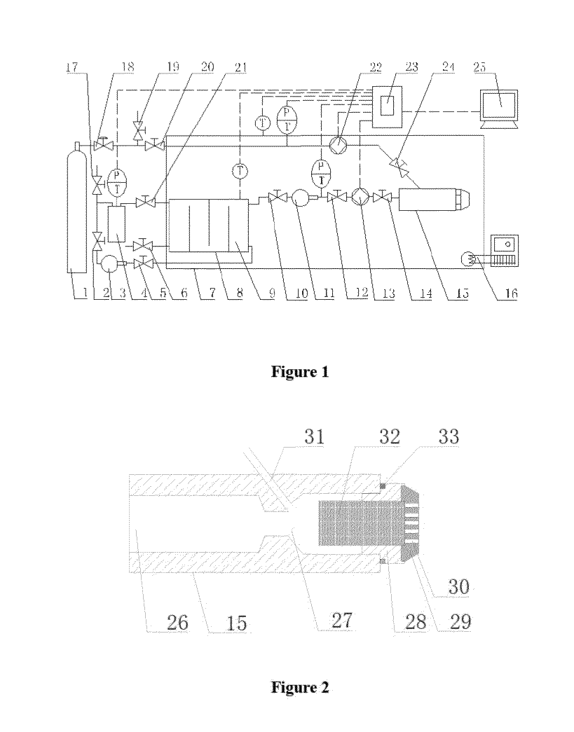

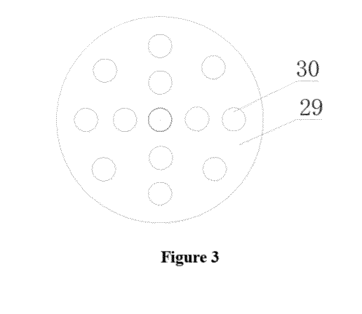

As shown in FIG. 1, a spraying device for quickly forming gas hydrates mainly includes a stable gas supply system, a saturated solution preparation system, a gas-liquid mixed sprayer 15, a temperature control system and a data collecting and processing system, which are connected by pipelines or circuits; the stable gas supply system is composed of a test gas cylinder 1 filled with a test gas, a CO, gas cylinder 4 for preparing a saturated solution, a pressure reducing valve 18 and a booster pump 3; the saturated solution preparation system is composed of a solution tank 8 and a booster pump 11; the interior of the gas-liquid mixed sprayer 15 mainly includes a high speed fluid cavity 26, a gas-liquid mixing cavity 27 communicated with the high speed fluid cavity 26 and an atomizer 32 arranged in the gas-liquid mixing cavity 27; the test gas cylinder 1 is communicated with the gas-liquid mixing cavity 27 of the gas-liquid mixed sprayer 15 through the pressure reducing valve 18 and a gas flowmeter 22; two gas pipelines are arranged at the top end of the CO₂ gas cylinder 4, one gas pipeline is communicated with the bottom of the solution tank 8 through the booster pump 3, and the other gas pipeline is communicated with the top of the solution tank 8 through a valve 21; the solution tank 8 is communicated with the high speed fluid cavity 26 of the gas-liquid mixed sprayer 15 through a valve 10, the booster pump 11, a valve 12 and a liquid flowmeter 13 in sequence; the temperature control system includes a temperature control refrigerating system 16 and a constant temperature chamber 7 arranged at the peripheries of the solution tank 8 and the gas-liquid mixed sprayer 15, and the temperature control system controls the temperature change of the solution tank 8 and the gas-liquid mixed sprayer 15, the data collecting and processing system includes the liquid flowmeter: 13, the gas flowmeter 22, a data collector 23 and a computer processing system 25.

The stable gas supply system provides a gas for the saturated solution preparation system or the gas-liquid mixed sprayer 15, the saturated solution preparation system provides the saturated solution for the gas-liquid mixed sprayer 15, the temperature control system controls the temperature change of the solution tank 8 and the gas-liquid mixed sprayer 15, and the data collecting and processing system is used for controlling, collecting, storing and analyzing the temperature, pressure, gas flow and liquid flow data of the stable gas supply system, the saturated solution preparation system, the gas-liquid mixed sprayer 15 and the temperature control system.

As shown in FIG. 2, the interior of the gas-liquid mixed sprayer 15 is hollow, and trapezoidal projections are symmetrically arranged on the inner wall to divide the interior of the gas-liquid mixed sprayer 15 into the high speed fluid cavity 26 and the gas-liquid mixing cavity 27, which are intercommunicated: a gas flow inlet 31 is formed in the convex end close to the high speed fluid cavity 26 in the gas-liquid mixing cavity 27, and the gas-liquid mixed sprayer 15 further includes an atomizer 32 arranged in the gas-liquid mixing cavity 27, a spray head 29 arranged at the outer end of the atomizer 32 and distributors 30 uniformly distributed on the spray head 29.

The atomizer 32 is fixedly connected with the wall of the gas-liquid mixed sprayer 15 through a threaded connector 28 and a gasket 33.

The spray head 29 is annular, is connected with the atomizer 32 through internal threads and is detachable.

The inside diameter of the distributor 30 is 0.04-1.0 mm.

When at work, the CO₂ gas in the CO₂ gas cylinder 4 enters from the bottom of the solution tank 8 under the boosting of the booster pump 3 to be frilly mixed with and dissolved in deionized water 9 filled in the solution tank 8, and then flows out from the top of the solution tank 8 and returns to the CO₂ gas cylinder 4 through a valve 21 to achieve the circulation of CO₂. Three hours later, a CO₂ saturated solution is formed in the solution tank 8, the CO₂ saturated solution enters the high speed fluid cavity 26 of the gas-liquid mixed sprayer 15 at a high speed after being boosted by the booster pump 11, vacuum is formed in the gas-liquid mixing cavity 27, the test gas in the test gas cylinder 1 directly enters the gas-liquid mixing cavity 27 of the gas-liquid mixed sprayer 15 under the action of a negative pressure through the pressure reducing valve 18, a valve 20 and the gas flowmeter 22 to achieve flow supply; the test gas provided by the stable gas supply system is fully mixed with the CO₂ saturated solution provided by the saturated solution preparation system in the gas-liquid mixing cavity 27, the fully mixed gas-liquid system enters the atomizer 32 to be atomized to fog drops of 5-10 microns, then the fog drops enter the spray head 29 and are sprayed into a gas hydrate reactor at a certain pressure by means of the distributors 30 with inside diameter of 0.04-1.0 mm. The temperature control system controls the temperature change of the solution tank 8 and the gas-liquid mixed sprayer 15; the data collecting and processing system controls, collects, stores and analyzes the temperature, pressure, gas flow and liquid flow data of the stable gas supply system, the saturated solution preparation system the gas-liquid mixed sprayer 15 and the temperature control system.

### Application Embodiment 1

At a temperature condition of 277.15 K, the CO₂ gas circularly flows in the solution tank 8 and is fully mixed with 0.29 mol % TBAB solution to form a CO₂ saturated TBAB solution three hours later. The saturated TBAB solution enters the high speed fluid cavity 26 of the gas-liquid mixed sprayer 15 at a high speed after being boosted by the booster pump 11 to 3.5 MPa, vacuum is formed in the gas-liquid mixing cavity 27, the test gas (a CO₂/H₂ mixed gas with a volume ratio of 40.0/60.0%) in the test gas cylinder 1 directly enters the gas-liquid mixing cavity 27 of the gas-liquid mixed sprayer 15 under the action of a negative pressure through the pressure reducing valve 18 and the gas flowmeter 22, and after being fully mixed in the gas-liquid mixing cavity 27, the test gas and the saturated aqueous solution enter the atomizer 32 to be atomized to fog drops of 5-10 microns. The fog drops enter a gas hydrate reaction kettle filled with the test gas and with a pressure of 3.0 MPa through the distributors 30 with inside diameter of 0.5 mm, and after the fog drops enter the gas hydrate reaction kettle, a large quantity of gas hydrates are formed within half minute. Under the same temperature and pressure conditions, the induction time of the same gas and solution system for forming the gas hydrates is shortened by about 10 times compared with that of mechanical stirring.

The case indicates that the spraying device for quickly forming gas hydrates can be used for greatly shortening the induction time of an synthesis gas for forming the gas hydrates.

### Application Embodiment 2

The application embodiment is the same as the application embodiment 1 except the difference that the test gas in the test gas cylinder 1 is a CO₂/H₂ mixed gas with a volume ratio of 18.0/82.0%. Under the same temperature and pressure conditions, the induction time of the same gas and solution system for forming the gas hydrates is shortened by about 18 times compared with that of mechanical stirring.

The case indicates that the present invention can be used for greatly shortening the induction time of the CO₂/H₂ mixed gas with lower CO₂concentration for forming the gas hydrates.

### Application Embodiment 3

The application embodiment is the same as the application embodiment 1 except the difference that the inside diameter of the distributor is 0.1 mm. Under the same temperature and pressure conditions, the induction time of the same gas and solution system for forming the gas hydrates is shortened by about 12 times compared with that of mechanical stirring. The case indicates that the spraying device for quickly forming gas hydrates can be used for greatly shortening the induction time of the ICTCC synthesis gas for forming the gas hydrates, and moreover, the smaller the size of the distributor is, the better the benefit of shortening the induction time is.

### Application Embodiment 4

The application embodiment is the same as the application embodiment 1 except the difference that the inside diameter of the distributor is 0.04 mm. Under the same temperature and pressure conditions, the induction time of the same gas and solution system for forming the gas hydrates is shortened by about 23 times compared with that of mechanical stirring. The case indicates that the spraying device for quickly forming gas hydrates can be used for greatly shortening the induction time of the ICTCC synthesis gas for forming the gas hydrates, and moreover, the smaller the size of the distributor is, the better the benefit of shortening the induction time is.

### Application Embodiment 5

The application embodiment is the same as the application embodiment 1 except the difference that the inside diameter of the distributor is 1.0 mm. Under the same temperature and pressure conditions, the induction time of the same gas and solution system for forming the gas hydrates is shortened by about 3 times compared with that of mechanical stirring. The case indicates that the spraying device for quickly forming gas hydrates can be used for greatly shortening the induction time of the IGCC synthesis gas for forming the gas hydrates, and moreover, the smaller the size of the distributor is the better the benefit of shortening the induction time is.

1. A spraying device for quickly forming gas hydrates, comprising:
a stable gas supply system;
a saturated solution preparation system;
a gas-liquid mixed sprayer;
a temperature control system; and
a data collecting and processing system, which are connected by at least one of pipelines and circuits,
wherein the stable gas supply system provides a gas for the saturated solution preparation system and the gas-liquid mixed sprayer, the stable gas supply system including:
a test gas cylinder;
a CO₂ gas cylinder;
a pressure reducing valve; and
a booster pump,
wherein the saturated solution preparation system provides a saturated solution for the gas-liquid mixed sprayer, the saturated solution preparation system including:
a solution tank; and
a booster pump,
wherein an interior of the gas-liquid mixed includes:
a high speed fluid cavity;
a gas-liquid mixing cavity communicating with the high speed fluid cavity; and
an atomizer arranged in the gas-liquid mixing cavity,
wherein the test gas cylinder communicates with the gas-liquid mixing cavity of the gas-liquid mixed sprayer through the pressure reducing valve and a gas flowmeter,
wherein two gas pipelines are arranged at the top end of the CO₂ gas cylinder, one gas pipeline of said two gas pipelines communicates with a bottom of the solution tank through the booster pump, and the other gas pipeline of said two as pipelines communicates with a top of the solution tank,
wherein the solution tank communicates with the high speed fluid cavity of the gas-liquid mixed sprayer through the booster pump,
wherein the temperature control system controls the temperature change of the solution tank and the gas-liquid mixed sprayer, the temperature control system including:
a temperature control refrigerating system; and
a constant temperature chamber arranged at peripheries of the solution tank and the gas-liquid mixed sprayer,
wherein the data collecting and processing system controls, collects, stores and analyzes a temperature, a pressure, a gas flow and a liquid flow data of the stable gas supply system, the saturated solution preparation system, the gas-liquid mixed sprayer and the temperature control system, the data collecting and processing system including:
a liquid flowmeter;
the gas flowmeter;
a data collector; and
a computer processing system.

2. The spraying device for quickly forming gas hydrates of claim 1,
wherein the interior of the gas-liquid mixed sprayer is hollow, and trapezoidal projections are symmetrically arranged on an inner wall of the gas-liquid mixed sprayer to divide the interior of the gas-liquid mixed sprayer into the high speed fluid cavity and the gas-liquid mixing cavity, which are intercommunicated; a gas flow inlet is formed in the convex end close to the high speed fluid cavity in the gas-liquid mixing cavity, and
wherein the gas-liquid mixed sprayer further comprises;
a spray head arranged at an outer end of the atomizer; and
distributors uniformly distributed on the spray head.

3. The spraying device for quickly forming gas hydrates of claim 2, wherein the spray head is annular and detachable.

4. The spraying device for quickly forming gas hydrates of claim 2, wherein the spray head is connected with the atomizer through internal threads.

5. The spraying device for quickly forming gas hydrates of claim 2, wherein an inside diameter of the distributor is 0.04-1.0 mm.

6. The spraying device for quickly forming gas hydrates of claim 1, wherein the atomizer is fixedly connected with the wall of the gas-liquid mixed sprayer through a threaded connector and a gasket.

7. The spraying device for quickly forming gas hydrates of claim 1 applied to thermodynamics and kinetics experiments of quick and continuous hydrate method gas separation and rapid formation of the gas hydrates.

8. The spraying device for quickly forming gas hydrates of claim 3, wherein the spray head is connected with the atomizer through internal threads.

9. The spraying device for quickly forming gas hydrates of claim 3, wherein an inside diameter of the distributor is 0.04-1.0 mm.
